(19) United States
(12) Patent Application Publication
(10) Pub. No.: US 2026/0335842 A1
(43) Pub. Date: Oct. 29, 2026

(54) PREPARATION METHOD FOR HIGH-PERFORMANCE IMIDAZOLE-BASED POLY(IONIC LIQUID) MEMBRANE

(71) Applicants: Baway Technology(Weifang) Co., Ltd., Weifang (CN); Qingdao University of Science and Technology, Qingdao (CN); ALLIED PLANET LIMITED, Hong Kong (CN)

(72) Inventors: Hongbing Song, Qingdao (CN); Hongxin Wang, Qingdao (CN); Fengli Wu, Weifang (CN); Yongfeng Hao, Weifang (CN); Xiaobo Li, Weifang (CN); Yong Li, Weifang (CN)

(21) Appl. No.: 19/685,525

(22) Filed: May 22, 2026

Related U.S. Application Data
(63) Continuation of application No. PCT/CN2026/091036, filed on Apr. 16, 2026.

(30) Foreign Application Priority Data
Apr. 27, 2025 (CN) 202510535550.1

(51) Int. Cl. B01D 71/64; B01D 67/00; B01D 69/10

(52) U.S. Cl. CPC B01D 71/64; B01D 67/0006; B01D 69/105; B01D 69/108

(57) ABSTRACT

A preparation method for a high-performance imidazole-based poly(ionic liquid) (PIL) membrane includes the following steps: using N-methylpyrrolidone as a solvent, reacting 2-phenylbenzimidazole or 2,4,5-triphenylimidazole with 4,4′-difluorodiphenyl sulfone, 1,4-dibromobenzene, 4,4′-dibromobiphenyl, or 4,4″-dibromo-p-terphenyl in a hydrothermal reactor, followed by washing and drying to obtain a first product; under the catalysis of a super strong organic acid, reacting the first product with biphenyl or p-terphenyl and N-methyl-4-piperidone, followed by washing and drying; reacting in an alkaline environment with the addition of iodomethane, followed by washing and drying to obtain PIL; and dissolving the PIL in dimethyl sulfoxide, coating the solution on a glass plate, and drying the coated solution to form a membrane. The PIL membrane prepared by the present disclosure has more ionic sites, significantly improving ionic conductivity. The membrane has high chemical and mechanical stability and broad application prospects.

### CROSS-REFERENCE TO RELATED APPLICATIONS

This application is a continuation of PCT/CN2026/091036, filed on Apr. 16, 2026 and claims priority of Chinese Patent Application No. 202510535550.1, filed on Apr. 27, 2025, the entire contents of which are incorporated herein by reference.

### TECHNICAL FIELD

The present disclosure belongs to the technical field of ion membrane preparation, more specifically, relates to a preparation method for a high-performance imidazole-based poly(ionic liquid) (PIL) membrane.

### BACKGROUND

Environmental pollution, as a global issue, not only causes immeasurable damage to the ecological balance of nature but also affects the sustainable development of human society. In recent years, geological damage and environmental pollution caused by the extraction and use of non-renewable fossil fuels have exacerbated the global energy crisis and ecological crisis, causing irreversible damage to the environment. Therefore, it is urgent to develop green and sustainable clean energy to replace traditional industrial methods, thereby promoting the green transformation of socio-economic development. Under the dual-carbon goals of carbon peak and carbon neutrality, hydrogen energy, as an emerging clean energy source, is considered one of the most promising energy sources in the world today due to its advantages of being green, pollution-free, high safety, and diverse application scenarios. Many countries and regions have already formulated hydrogen energy development strategies, increased research and development efforts in hydrogen energy technology, and gradually improved the formation and refinement of the hydrogen energy industry chain. Currently, hydrogen energy is widely used in industries such as industry, transportation, power, and construction, becoming a new pillar of global energy transition. Unlike gray hydrogen produced from fossil fuels and blue hydrogen produced from natural gas, hydrogen produced by electrolyzing water is called green hydrogen, which almost produces no carbon emissions and is also known as “zero-carbon hydrogen,” considered the most environmentally friendly option. As awareness and actions to reduce carbon emissions and protect the ecological environment continue to increase, electrolysis of water for hydrogen production is regarded as the most promising energy source.

Room-temperature electrolysis of water for hydrogen production technology mainly includes alkaline water electrolysis (AWE), proton exchange membrane water electrolysis (PEMWE), and anion exchange membrane water electrolysis (AEMWE). AWE, because it uses high-concentration alkaline solutions as the electrolyte, easily causes corrosion to equipment. Moreover, the distance between the electrodes and the membrane is relatively large, resulting in an increased volume of the electrolyzer. The cathode/anode catalysts of PEMWE electrolyzers mainly rely on platinum-group precious metal materials with scarce reserves and high prices, and proton exchange membranes mainly rely on fluorocarbon membranes, increasing usage costs, which limits the large-scale application of PEMWE technology to some extent. AEMWE combines the advantages of low cost of AWE and the high efficiency and convenience of PEMWE. Replacing hydrogen ions (H⁺) with hydroxide ions (OH⁻), anion exchange membranes working in alkaline environments require lower redox potentials, have higher kinetics, and can use non-platinum group metals as electrodes, such as nickel and cobalt, to achieve excellent hydrogen evolution performance. This avoids the use of platinum group precious metal electrode catalysts, greatly reducing production costs. Moreover, using pure water or low-concentration alkaline solutions as the electrolyte reduces the corrosiveness of strong alkaline solutions to equipment. The advantages of AEMWE, such as cost-effectiveness, mild operating conditions, environmental friendliness, and strong adaptability, make it gradually become the most promising green hydrogen production method, increasingly favored by the market.

However, AEMWE is in its early stages of development and still faces many problems that need urgent resolution, such as chemical stability and mechanical performance stability. Due to the operating humidity of AEMWE being close to 100% and temperature greater than 80 °C, anion exchange membranes easily absorb water, leading to high swelling ratios, resulting in lower chemical stability and a service life far shorter than that of proton exchange membranes. Additionally, OH⁻ conductivity is also relatively low, causing the ionic conductivity of anion exchange membranes to be lower than that of proton exchange membranes, limiting ion transport efficiency and directly affecting the commercial application of anion exchange membranes. To solve these problems, it is necessary to further improve the performance of membrane materials, and enhance membrane lifespan and electrolysis efficiency, requiring further technological maturation and cost optimization. Therefore, developing low-cost, chemically stable, and mechanically stable anion exchange membranes is particularly urgent.

### SUMMARY

The technical problem the present disclosure aims to solve is to provide a preparation method for a high-performance imidazole-based poly(ionic liquid) (PIL) membrane, to overcome defects and deficiencies existing in the prior art. This preparation method designs and optimizes the structure of the ion membrane through the structure of the imidazole-based PIL, effectively solving the problems of low ionic conductivity, poor alkali resistance, and insufficient mechanical performance. The PIL membrane prepared by this method has a high number of ionic sites, which is beneficial for ion transport and improves ion exchange capacity. Moreover, this molecular structure has a high molecular weight, enhancing tensile strength and elongation at break, and greatly improving its chemical stability and mechanical performance stability. The high-performance imidazole-based PIL membrane of the present disclosure has good application prospects in electrolysis of water for hydrogen production and water treatment.

An objective of the present disclosure is to provide a preparation method for a high-performance imidazole-based PIL membrane.

The above objective of the present disclosure is achieved through the following technical solution:

A preparation method for a high-performance imidazole-based PIL membrane includes the following steps (1)-(5).

In step (1), 2-phenylbenzimidazole or 2,4,5-triphenylimidazole, 4,4′-difluorodiphenyl sulfone, 1,4-dibromobenzene, 4,4′-dibromobiphenyl or 4,4″-dibromo-p-terphenyl, and N-methylpyrrolidone are mixed uniformly, then materials are placed into a hydrothermal reactor for reaction, a product is washed with deionized water after the reaction, and a washed product is dried in a vacuum drying oven to obtain a first product.

In step (2), in a three-necked flask filled with an inert gas, dichloromethane is used as a solvent, the first product, biphenyl or p-terphenyl, and N-methyl-4-piperidone are added, the materials are stirred, a strong organic acid is slowly added, allowing the reaction to proceed, with the color gradually changing from pink to purple, and a product is poured into excess methanol, precipitating a solid, to obtain a second product.

In step (3), the second product is added into an alkaline solution to remove residual acid, stirring at room temperature of 20-30 °C, followed by drying in a vacuum drying oven after washing to obtain a third product.

In step (4), the third product is dissolved in N,N-dimethylformamide, iodomethane and potassium carbonate are added, the materials are stirred for reaction, a product is poured into excess ethyl acetate, precipitating a white solid, and the white solid is washed with deionized water, followed by vacuum drying to obtain a fourth product.

In step (5), the fourth product is dissolved in dimethyl sulfoxide, and supernatant is taken and coated on a dry and clean glass plate, followed by drying; and an obtained PIL membrane is placed into an alkaline solution for ion exchange, to obtain the high-performance imidazole-based PIL membrane.

Further, in step (1), used 2-phenylbenzimidazole or 2,4,5-triphenylimidazole and 4,4′-difluorodiphenyl sulfone, 1,4-dibromobenzene, 4,4′-dibromobiphenyl, or 4,4″-dibromo-p-terphenyl have a molar ratio of 2-8:2-10; the reaction is performed at a temperature of 50-300 °C for a time of 3-20 hours; and the drying is performed at 50-80 °C for 10-25 hours.

Further, in step (2), used first product, biphenyl or p-terphenyl and N-methyl-4-piperidone have a molar ratio of 1-7:3-12:2-15; the inert gas is nitrogen or argon; and the reaction is performed at a temperature of −10-20 °C for a time of 2-12 hours.

Further, in step (2), the stirring is performed at a speed of 100-800 r·min⁻¹; and the strong organic acid is one or more of trichloroacetic acid, trifluoroacetic acid, and trifluoromethanesulfonic acid, and is added dropwise at a rate of 0.01-10 mL·min⁻¹.

Further, in step (3), the alkaline solution is one of a potassium carbonate solution, a sodium carbonate solution, a sodium bicarbonate solution, and a potassium bicarbonate solution, with a concentration of 0.01-15 mol·L⁻¹.

Further, in step (3), the washing is performed with deionized water until a pH is 6.5-7.5.

Further, in step (3), the stirring is performed for a time of 5-24 hours, and the drying is performed at a temperature of 50-80 °C for a time of 10-30 hours.

Further, in step (4), the third product is dissolved in N,N-dimethylformamide, with a solution concentration of 0.05-10%, and the reaction proceeds in the dark; the stirring is performed at a temperature of 30-50 °C for a time of 10-40 hours, with a stirring speed of 100-800 r·min⁻¹; and the vacuum drying is performed at a temperature of 50-80 °C for a time of 10-30 hours.

Further, in step (5), the fourth product and dimethyl sulfoxide are prepared into a solution with a concentration of 0.01-15%.

Further, in step (5), the prepared PIL membrane undergoes ion exchange in 0.01-5 mol·L⁻¹ NaOH or KOH for 5-72 hours.

A high-performance imidazole-based PIL membrane is provided, which is prepared based on the above-described preparation method for a high-performance imidazole-based PIL membrane, and used for electrolysis of water for hydrogen production.

The present disclosure has the following beneficial effects:

(1) The PIL membrane prepared by the present disclosure has excellent mechanical performance. The molecular structure of the present disclosure has a high molecular weight, and a high molecular weight structure can enhance the mechanical performance of the membrane, improving the tensile resistance of the membrane. The membrane after OH-exchange achieves a tensile strength of 60 MPa. The membrane designed in the present disclosure has excellent flexibility. After repeatedly folding the PIL membrane for several times, no cracks or breakage appear, and the membrane can still return to its original state. Therefore, the PIL membrane of the present disclosure greatly improves the tensile strength and elongation at break through the entangled polymer structure.

(2) The PIL membrane prepared by the present disclosure has good ionic conductivity. The membrane structure of the present disclosure is a polymer with multiple ionic sites, improving ion transport capability. Therefore, the membrane of the present disclosure has excellent ion exchange capacity, improves ion conduction efficiency, and thus possesses high ionic conductivity.

(3) The PIL membrane prepared by the present disclosure has a low swelling ratio. A high swelling ratio leads to poor alkali resistance of the membrane, affecting the service life of the membrane and increasing production costs. The membrane of the present disclosure avoids the problem of poor alkali resistance due to high swelling ratio. In 1 mol·L⁻¹ KOH, the ionic conductivity shows almost no decrease after 1,500 hours.

### BRIEF DESCRIPTION OF THE DRAWINGS

FIG. 1 shows structural formulas of monomers A1-A2 and B1-B4;

FIG. 2 shows structural formulas of combination of A and B;

FIG. 3 shows a polymerization reaction formula of AB combination with N-methylpiperidone, biphenyl, or p-terphenyl;

FIG. 4 shows structural formulas of polymers of A1B1C1 and A1B1C2 combinations;

FIG. 5 shows structural formulas of polymers of A1B2C1 and A1B2C2 combinations;

FIG. 6 shows structural formulas of polymers of A1B3C1 and A1B3C2 combinations;

FIG. 7 shows structural formulas of polymers of A1B4C1 and A1B4C2 combinations;

FIG. 8 shows structural formulas of polymers of A2B1C1 and A2B1C2 combinations;

FIG. 9 shows structural formulas of polymers of A2B2C1 and A2B2C2 combinations;

FIG. 10 shows structural formulas of polymers of A2B3C1 and A2B3C2 combinations;

FIG. 11 shows structural formulas of polymers of A2B4C1 and A2B4C2 combinations;

FIG. 12 shows structural formulas of A2B1C1-I and A2B1C1-OH (PMB-1) poly(ionic liquid) (PIL) membranes;

FIG. 13 shows ionic conductivity of a high-performance imidazole-based PIL membrane provided by the present disclosure;

FIG. 14 shows mechanical performance of the high-performance imidazole-based PIL membrane provided by the present disclosure;

FIG. 15 shows a swelling ratio of the high-performance imidazole-based PIL membrane provided by the present disclosure; and

FIG. 16 shows a thermogravimetric diagram of the high-performance imidazole-based PIL membrane provided by the present disclosure.

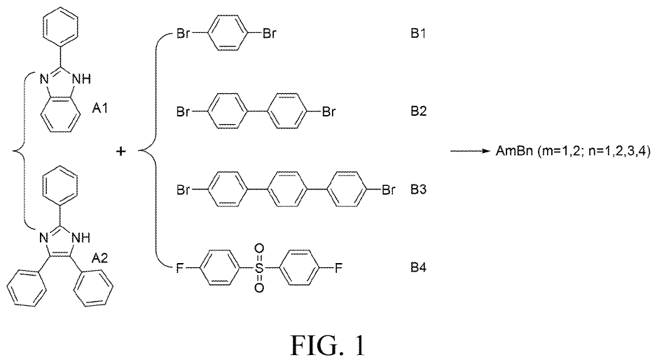

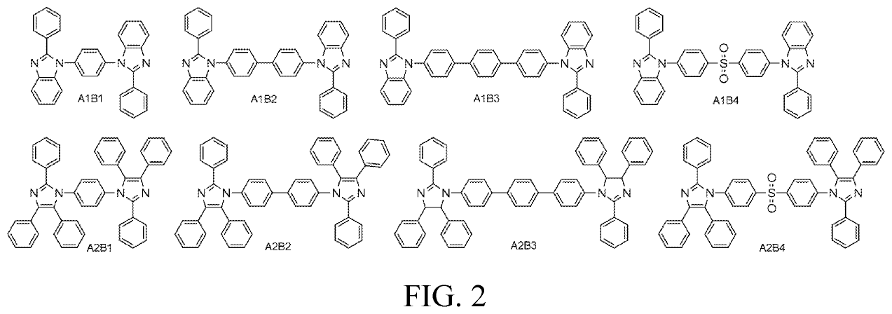

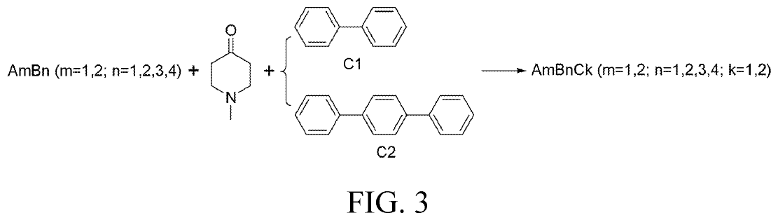

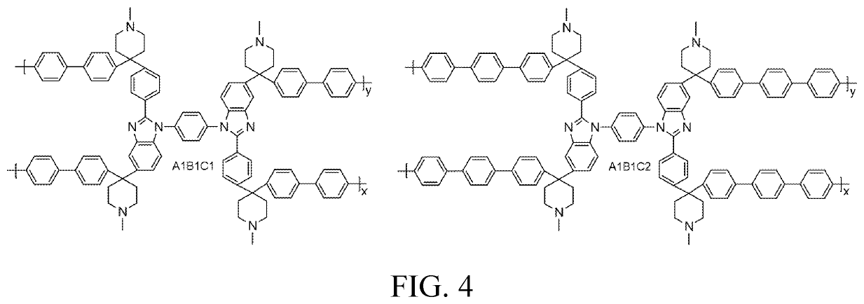

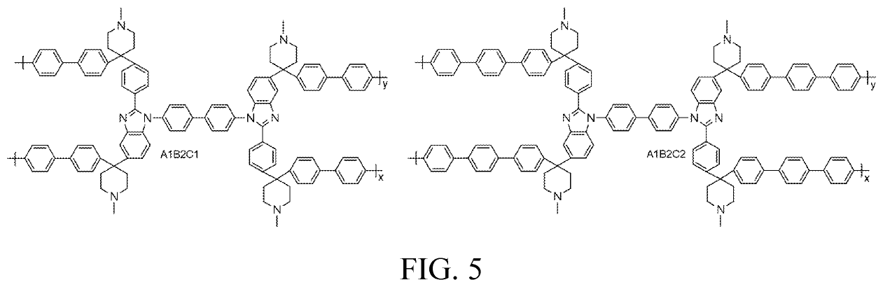

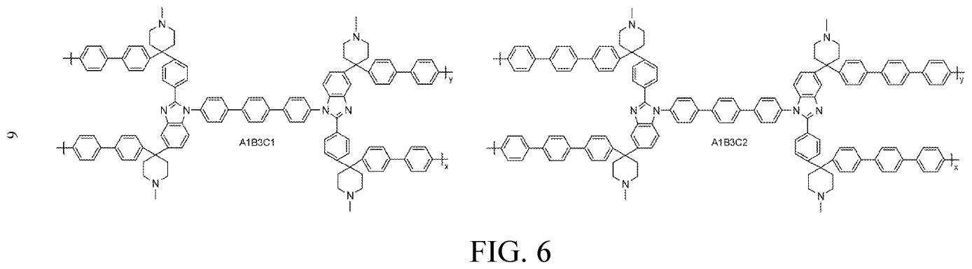

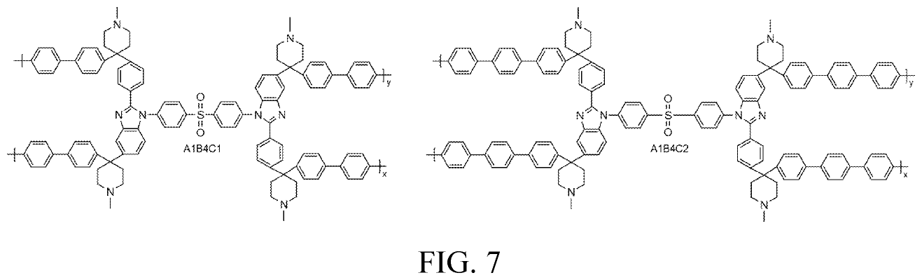

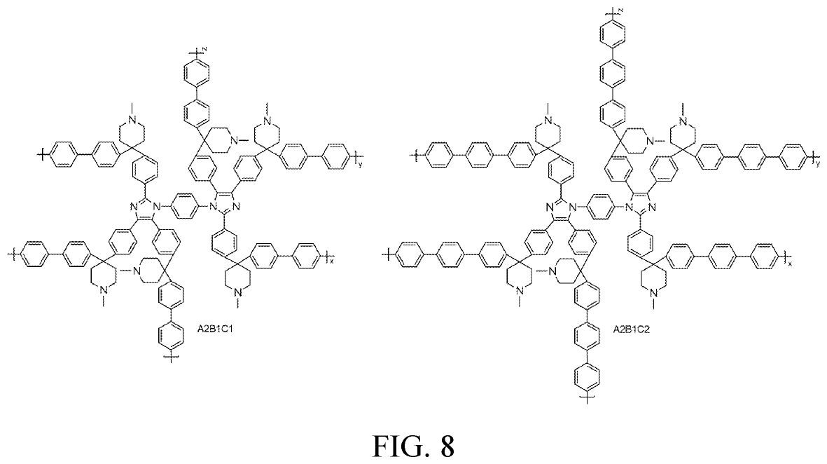

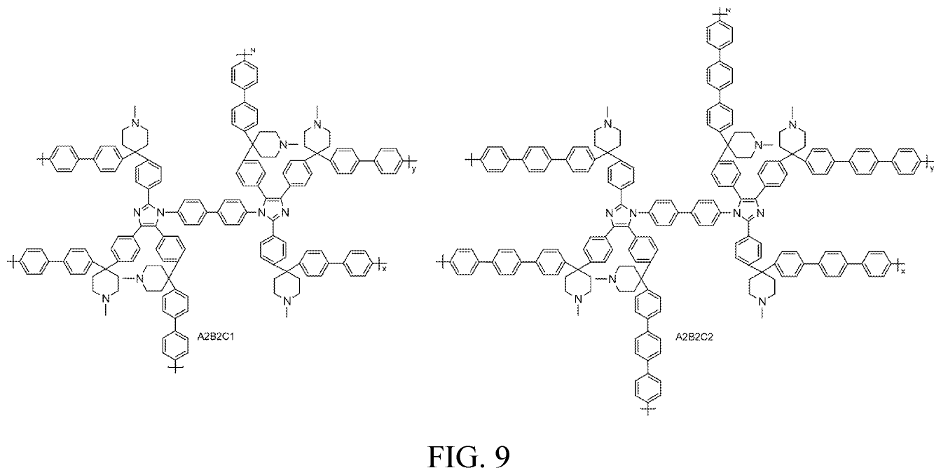

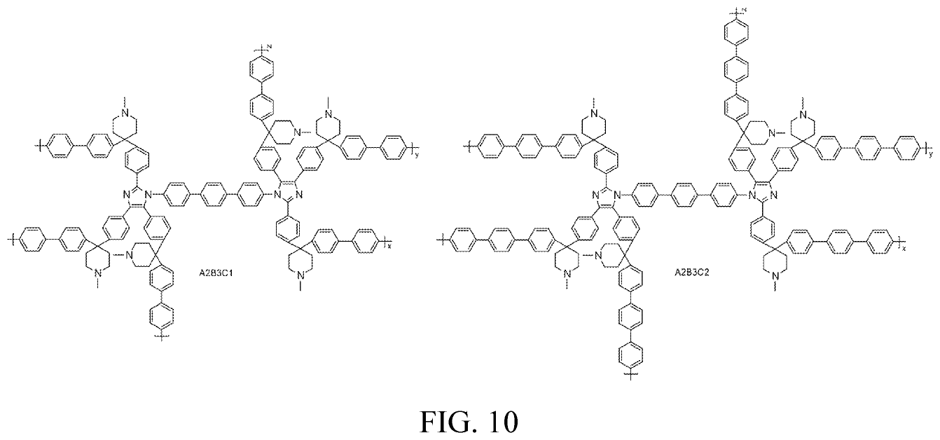

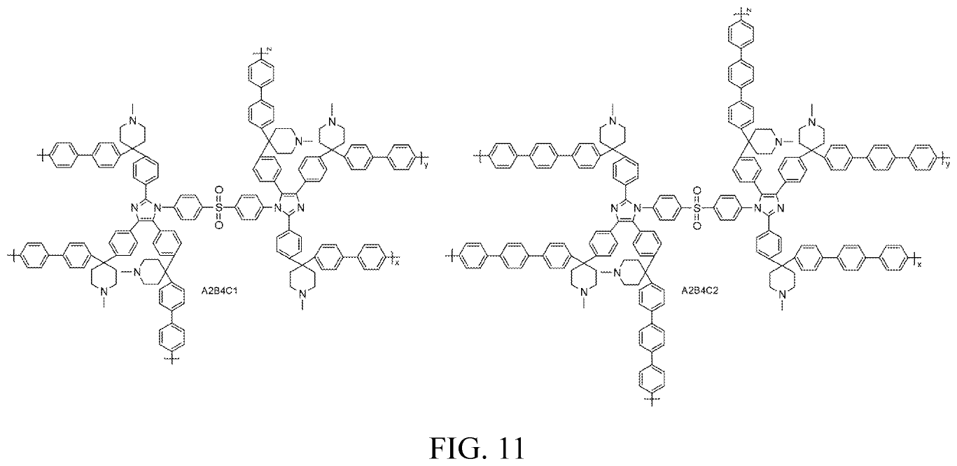

### DETAILED DESCRIPTION

The following describes the present disclosure in further detail with specific examples, but the examples do not limit the present disclosure in any form. Unless otherwise specified, the reagents, methods, and equipment used in the present disclosure are conventional in this technical field.

When equivalents, concentrations, or other values or parameters are expressed as a range, a preferred range, or a series of upper and lower preferred values, it is to be understood to specifically disclose all ranges formed by any pairing of an upper range limit or preferred value with a lower range limit or preferred value, whether or not the range is separately disclosed. For example, when the range “1 to 5” is disclosed, the described range should be interpreted as including ranges “1 to 4”, “1 to 3”, “1 to 2”, “1 to 2 and 4 to 5”, “1 to 3 and 5”, etc. When a numerical range is described in this text, unless otherwise stated, the range is intended to include its endpoints and all integers and fractions within the range.

The indefinite article “a” or “an” before an element or component of the present disclosure places no limitation on the quantity (i.e., number of occurrences) of the element or component. Therefore, “a” or “an” is to be interpreted as including one or at least one, and the singular form of an element or component also includes the plural form, unless the quantity clearly refers only to the singular form.

In addition, terms such as “an embodiment”, “some embodiments”, and “example” described in the present disclosure mean that specific features, structures, materials, or characteristics described in connection with the embodiment or example are included in at least one embodiment or example of the present disclosure. In this specification, schematic expressions of the above terms are not necessarily directed to the same embodiment or example. Moreover, the technical features involved in the various embodiments of the present disclosure can be combined with each other as long as they do not conflict with each other.

Unless otherwise specified, the reagents and materials used in the following examples are commercially available.

In at least one embodiment, a high-performance imidazole-based poly(ionic liquid) (PIL) membrane was prepared by the following steps (1)-(5).

(1) 1.48 g (5 mmol) of 2,4,5-triphenylimidazole, 1.87 g (8 mmol) of 1,4-dibromobenzene, and 30 mL of N-methylpyrrolidone were mixed uniformly, then placed into a reaction kettle, and reacted at 100 °C for 6 hours. After the reaction, a product was washed with deionized water for 5 times and dried in a vacuum drying oven at 80 °C for 24 hours to obtain a product A2B1.

(2) In a three-necked flask filled with a nitrogen atmosphere, 20 mL of dichloromethane, 0.924 g (2 mmol) of A2B1, 0.57 g (5 mmol) of N-methyl-4-piperidone, and 0.31 g (2 mmol) of biphenyl were uniformly mixed and reacted for 1.5 hours, and 20 mL of trifluoromethanesulfonic acid was added dropwise at a speed of 1 mL·min⁻¹. The solution was stirred with a mechanical stirrer at 0 °C. After reacting for 4 hours, the solution gradually changed from pink to a purple viscous substance. A product was poured into excess methanol to obtain a white precipitate.

(3) The white precipitate from step (2) was added to a 0.1 mol·L⁻¹ potassium carbonate solution, stirred at room temperature of 20-30 °C for 10 hours, washed with deionized water for 5 times, and then dried in a vacuum drying oven at 80 °C for 12 hours to obtain a product A2B1C1.

(4) 1 g of the product A2B1C1 was uniformly mixed with 10 mL of N,N-dimethylformamide, and 0.1 g of potassium carbonate and 0.3 mL of iodomethane were added. After reacting in the dark for 12 hours, a mixture was poured into ethyl acetate, precipitating a white solid. The solid was washed with deionized water for 3 times, and dried in a vacuum drying oven at 80 °C for 24 hours to obtain a product A2B1C1-I.

(5) The product A2B1C1-I was dissolved in dimethyl sulfoxide to prepare a 0.5% solution, which was then coated on a clean glass plate and heated at 120 °C for 12 hours to obtain a membrane. The membrane was placed in 0.5 mol·L⁻¹ NaOH for ion exchange for 12 hours to obtain a PIL membrane A2B1C1-OH (PMB-1).

The PIL membrane prepared by the above steps was used, and all electrochemical measurements were performed on a Shanghai Chenhua CHI760E electrochemical workstation. An ionic conductivity test was conducted using a Chenhua ionic conductivity test fixture. Under a four-electrode configuration, using an open circuit voltage as a test voltage for impedance, impedance tests were conducted at different temperatures. An ionic conductivity calculation formula is:

$$σ = \frac{L}{A \times R} ,$$

where L is a distance between a working electrode and a counter electrode, R is a test impedance, and A is a cross-sectional area of the membrane. The mechanical performance of the PIL membrane was tested on a thin film tensile testing machine. A film was cut into a dumbbell shape, and a test speed was 2 mm min⁻¹. The swelling ratio and water absorption of the PIL membrane were tested by placing the PIL membrane in pure water at different temperatures. After 24 hours, surface water was wiped off, and the length (L_{wet}) and weight (W_{wet}) were quickly recorded. Then, the PIL membrane was dried at 80 °C for 24 hours, and the length (L_{dry}) and weight (W_{dry}) were recorded. A water absorption calculation formula is:

$$WU = \frac{{W}_{wet} - {W}_{dry}}{{W}_{dry}} \times 100 \% .$$

A swelling ratio calculation formula is:

$$SR = \frac{{L}_{{wet}^{-}} {L}_{dry}}{{L}_{dry}} \times 1 \; 00 \% .$$

The high-performance imidazole-based PIL membrane refers to an imidazole-based PIL membrane with tensile strength greater than 40 MPa.

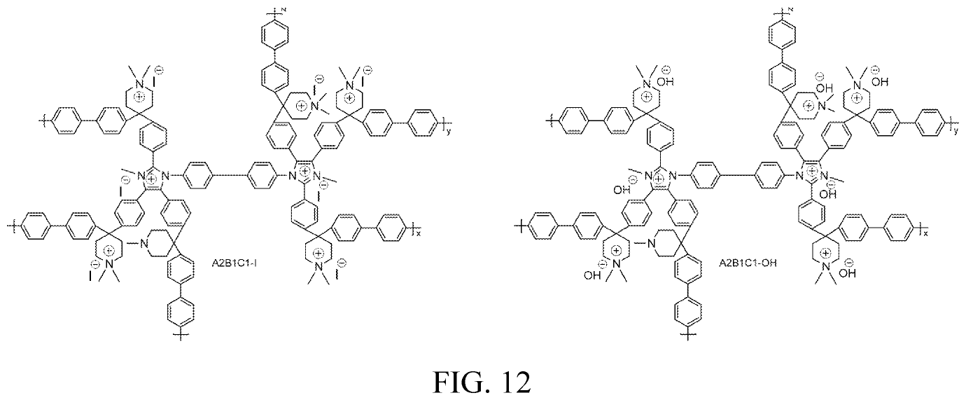

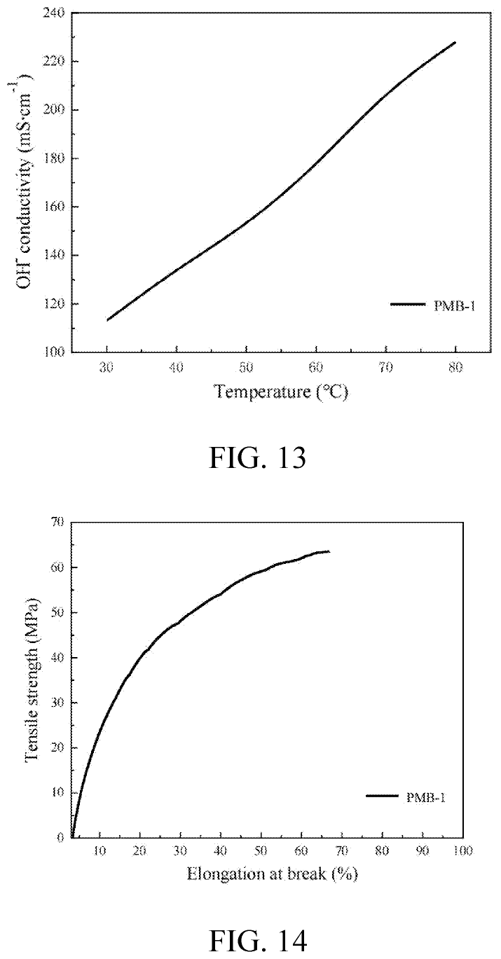

FIG. 13 shows an ionic conductivity diagram of the imidazole-based PIL membrane prepared by the above steps. As the temperature increased, the ionic conductivity also gradually increased. When the temperature was 30 °C, the ionic conductivity was greater than 100 mS·cm⁻¹. When the temperature was raised to 80 °C, the ionic conductivity was higher than 200 mS·cm⁻¹. The increase in temperature greatly promoted the transport of OH-ions, thereby improving the ion exchange capacity and effectively increasing the ionic conductivity. Compared with other PIL membranes, the PIL membrane of the present disclosure has an absolute advantage in ionic conductivity value.

FIG. 14 shows a mechanical performance diagram of the imidazole-based PIL membrane prepared by the above steps for electrolysis of water. At a tensile speed of 2 mm·min⁻¹, the tensile strength of the OH-exchanged PIL membrane was measured to be 63.56 MPa, and the elongation at break was 66.92%. This is much higher than the mechanical performance tests of other PIL membranes. It indicates that the PIL membrane prepared in the present disclosure has excellent mechanical performance stability.

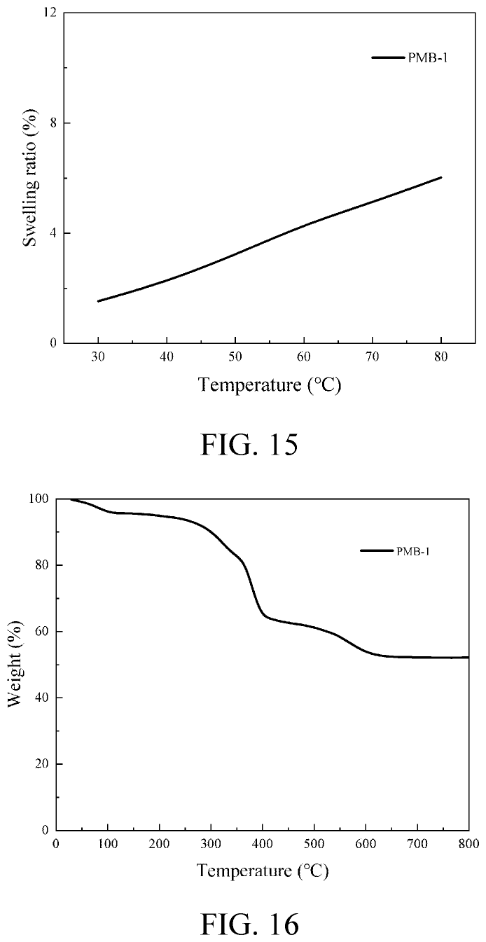

FIG. 15 shows a swelling ratio diagram of the imidazole-based PIL membrane prepared by the above steps. As the temperature increased, the swelling ratio of the PIL membrane gradually increased, but the increase was small. This is mainly related to the branched chain of the polymer structure, as the branched structure limits the swelling of the PIL membrane in the present disclosure. The low swelling ratio of the PIL membrane is beneficial for improving the chemical stability of the membrane and increasing the service life of the PIL membrane.

FIG. 16 shows a thermogravimetric diagram of the imidazole-based PIL membrane prepared by the above steps. The test was conducted at 10 °C·min⁻¹ between 0 °C and 800 °C. Before 300 °C, the PIL membrane lost about 10%, including slight loss due to trace moisture. When heated to 800 °C, the mass loss of the PIL membrane of the present disclosure was about 50%. The mass loss between 300-400 °C is caused by the degradation of cationic groups and side chains. The mass loss between 500-650 °C is caused by the degradation of the polymer main chain.

In at least one embodiment, a high-performance imidazole-based PIL membrane was prepared by the following steps (1)-(5).

(1) 0.97 g (5 mmol) of 2-phenylbenzimidazole, 2.50 g (8 mmol) of 4,4′-dibromobiphenyl, and 30 mL of N-methylpyrrolidone were mixed uniformly, then placed into a reaction kettle, and reacted at 100 °C for 6 hours. After the reaction, a product was washed with deionized water for 5 times and dried in a vacuum drying oven at 80 °C for 24 hours to obtain a product A1B2.

(2) In a three-necked flask filled with a nitrogen atmosphere, 20 mL of dichloromethane, 0.924 g (2 mmol) of the product A1B2, 0.57 g (5 mmol) of N-methyl-4-piperidone, and 0.31 g (2 mmol) of biphenyl were uniformly mixed and reacted for 1.5 hours, and 20 mL of trifluoromethanesulfonic acid was added dropwise at a speed of 1 mL·min⁻¹. The solution was stirred with a mechanical stirrer at 0 °C. After reacting for 4 hours, the solution gradually changed from pink to a purple viscous substance. A product was poured into excess methanol to obtain a white precipitate.

(3) The white precipitate from step (2) was added to a 0.1 mol·L⁻¹ potassium carbonate solution, stirred at room temperature of 20-30 °C for 10 hours, washed with deionized water for 5 times, and then dried in a vacuum drying oven at 80 °C for 12 hours to obtain a product A1B2C1.

(4) 1 g of the product A1B2C1 was uniformly mixed with 10 mL of N,N-dimethylformamide, and 0.1 g of potassium carbonate and 0.3 mL of iodomethane were added. After reacting in the dark for 12 hours, a mixture was poured into ethyl acetate, precipitating a white solid. The solid was washed with deionized water for 3 times, and dried in a vacuum drying oven at 80 °C for 24 hours to obtain a product A1B2C1-I.

(5) The product A1B2C1-I was dissolved in dimethyl sulfoxide to prepare a 0.5% solution, which was then coated on a clean glass plate and heated at 120 °C for 12 hours to obtain a membrane. The membrane was placed in 0.5 mol·L⁻¹ NaOH for ion exchange for 12 hours to obtain a PIL membrane A1B2C1-OH. The tensile strength of PIL membrane A1B2C1-OH was measured to be 62.84 MPa, and the elongation at break was 67.13%.

In at least one embodiment, a high-performance imidazole-based PIL membrane was prepared by the following steps (1)-(5).

(1) 1.48 g (5 mmol) of 2,4,5-triphenylimidazole, 2.50 g (8 mmol) of 4,4′-dibromobiphenyl, and 30 mL of N-methylpyrrolidone were mixed uniformly, then placed into a reaction kettle, and reacted at 100 °C for 6 hours. After the reaction, a product was washed with deionized water for 5 times and dried in a vacuum drying oven at 80 °C for 24 hours to obtain a product A2B2.

(2) In a three-necked flask filled with a nitrogen atmosphere, 20 mL of dichloromethane, 1.08 g (2 mmol) of A2B2, 0.57 g (5 mmol) of N-methyl-4-piperidone, and 1.38 g (8 mmol) of p-terphenyl were uniformly mixed and reacted for 1.5 hours, and 20 mL of trifluoromethanesulfonic acid was added dropwise at a speed of 1 mL·min⁻¹. The solution was stirred with a mechanical stirrer at 0 °C. After reacting for 4 hours, the solution gradually changed from pink to a purple viscous substance. A product was poured into excess methanol to obtain a white precipitate.

(3) The white precipitate from step (2) was added to a 0.1 mol·L⁻¹ potassium carbonate solution, stirred at room temperature of 20-30 °C for 10 hours, washed with deionized water for 5 times, and then dried in a vacuum drying oven at 80 °C for 12 hours to obtain a product A2B2C2.

(4) 1 g of the product A2B2C2 was uniformly mixed with 10 mL of N,N-dimethylformamide, and 0.1 g of potassium carbonate and 0.3 mL of iodomethane were added. After reacting in the dark for 12 hours, a mixture was poured into ethyl acetate, precipitating a white solid. The solid was washed with deionized water for 3 times, and dried in a vacuum drying oven at 80 °C for 24 hours to obtain a product A2B2C2-I.

(5) The product A2B2C2-I was dissolved in dimethyl sulfoxide to prepare a 0.5% solution, which was then coated on a clean glass plate and heated at 120 °C for 12 hours to obtain a membrane. The membrane was placed in 0.5 mol·L⁻¹ NaOH for ion exchange for 12 hours to obtain a PIL membrane A2B2C2-OH. The tensile strength of PIL membrane A2B2C2-OH was measured to be 63.33 MPa, and the elongation at break was 67.06%.

In at least one embodiment, a high-performance imidazole-based PIL membrane was prepared by the following steps (1)-(5).

(1) 1.48 g (5 mmol) of 2,4,5-triphenylimidazole, 3.09 g (8 mmol) of 4,4″-dibromo-p-terphenyl, and 30 mL of N-methylpyrrolidone were mixed uniformly, then placed into a reaction kettle, and reacted at 100 °C for 6 hours. After the reaction, a product was washed with deionized water for 5 times and dried in a vacuum drying oven at 80 °C for 24 hours to obtain a product A2B3.

(2) In a three-necked flask filled with a nitrogen atmosphere, 20 mL of dichloromethane, 1.23 g (2 mmol) of A2B3, 0.57 g (5 mmol) of N-methyl-4-piperidone, and 0.31 g (2 mmol) of biphenyl were uniformly mixed and reacted for 1.5 hours, and 20 mL of trifluoromethanesulfonic acid was added dropwise at a speed of 1 mL·min⁻¹. The solution was stirred with a mechanical stirrer at 0 °C. After reacting for 4 hours, the solution gradually changed from pink to a purple viscous substance. A product was poured into excess methanol to obtain a white precipitate.

(3) The white precipitate from step (2) was added to a 0.1 mol·L⁻¹ potassium carbonate solution, stirred at room temperature of 20-30 °C for 10 hours, washed with deionized water for 5 times, and then dried in a vacuum drying oven at 80 °C for 12 hours to obtain a product A2B3C1.

(4) 1 g of the product A2B3C1 was uniformly mixed with 10 mL of N,N-dimethylformamide, and 0.1 g of potassium carbonate and 0.3 mL of iodomethane were added. After reacting in the dark for 12 hours, a mixture was poured into ethyl acetate, precipitating a white solid. The solid was washed with deionized water for 3 times, and dried in a vacuum drying oven at 80 °C for 24 hours to obtain a product A2B3C1-I.

(5) The product A2B3C1-I was dissolved in dimethyl sulfoxide to prepare a 0.5% solution, which was then coated on a clean glass plate and heated at 120 °C for 12 hours to obtain a membrane. The membrane was placed in 0.5 mol·L⁻¹ NaOH for ion exchange for 12 hours to obtain a PIL membrane A2B3C1-OH. The tensile strength of PIL membrane A2B3C1-OH was measured to be 64.15 MPa, and the elongation at break was 66.45%.

In at least one embodiment, a high-performance imidazole-based PIL membrane was prepared by the following steps (1)-(5).

(1) 1.48 g (5 mmol) of 2,4,5-triphenylimidazole, 2.03 g (8 mmol) of 4,4′-difluorodiphenyl sulfone, and 30 mL of N-methylpyrrolidone were mixed uniformly, then placed into a reaction kettle, and reacted at 100 °C for 6 hours. After the reaction, a product was washed with deionized water for 5 times and dried in a vacuum drying oven at 80 °C for 24 hours to obtain a product A2B4.

(2) In a three-necked flask filled with a nitrogen atmosphere, 20 mL of dichloromethane, 1.20 g (2 mmol) of A2B4, 0.57 g (5 mmol) of N-methyl-4-piperidone, and 0.31 g (2 mmol) of biphenyl were uniformly mixed and reacted for 1.5 hours, and 20 mL of trifluoromethanesulfonic acid was added dropwise at a speed of 1 mL·min⁻¹. The solution was stirred with a mechanical stirrer at 0 °C. After reacting for 4 hours, the solution gradually changed from pink to a purple viscous substance. A product was poured into excess methanol to obtain a white precipitate.

(3) The white precipitate from step (2) was added to a 0.1 mol·L⁻¹ potassium carbonate solution, stirred at room temperature of 20-30 °C for 10 hours, washed with deionized water for 5 times, and then dried in a vacuum drying oven at 80 °C for 12 hours to obtain a product A2B4C1.

(4) 1 g of the product A2B4C1 was uniformly mixed with 10 mL of N,N-dimethylformamide, and 0.1 g of potassium carbonate and 0.3 mL of iodomethane were added. After reacting in the dark for 12 hours, a mixture was poured into ethyl acetate, precipitating a white solid. The solid was washed with deionized water for 3 times, and dried in a vacuum drying oven at 80 °C for 24 hours to obtain a product A2B4C1-I.

(5) The product A2B4C1-I was dissolved in dimethyl sulfoxide to prepare a 0.5% solution, which was then coated on a clean glass plate and heated at 120 °C for 12 hours to obtain a membrane. The membrane was placed in 0.5 mol·L⁻¹ NaOH for ion exchange for 12 hours to obtain a PIL membrane A2B4C1-OH. The tensile strength of PIL membrane A2B4C1-OH was measured to be 64.31 MPa, and the elongation at break was 65.87%.

The above embodiments are preferred implementations of the present disclosure, but the implementations of the present disclosure are not limited by the above embodiments. Any other changes, modifications, substitutions, combinations, and simplifications made without departing from the spirit and principles of the present disclosure are to be equivalent replacement methods and are included within the protection scope of the present disclosure.

1. A preparation method for a high-performance imidazole-based poly(ionic liquid) (PIL) membrane, comprising the following steps:
(1) mixing 2-phenylbenzimidazole or 2,4,5-triphenylimidazole, 4,4′-difluorodiphenyl sulfone, 1,4-dibromobenzene, 4,4′-dibromobiphenyl or 4,4″-dibromo-p-terphenyl, and N-methylpyrrolidone uniformly, then placing materials into a hydrothermal reactor for reaction, washing a product with deionized water after the reaction, and drying a washed product in a vacuum drying oven to obtain a first product;
(2) in a three-necked flask filled with an inert gas, using dichloromethane as a solvent, adding the first product, biphenyl or p-terphenyl, and N-methyl-4-piperidone, stirring the materials, slowly adding a strong organic acid, allowing the reaction to proceed, with the color gradually changing from pink to purple, and pouring a product into excess methanol, precipitating a solid, to obtain a second product;
(3) adding the second product into an alkaline solution to remove residual acid, stirring at room temperature of 20-30 °C, followed by drying in a vacuum drying oven after washing to obtain a third product;
(4) dissolving the third product in N,N-dimethylformamide, adding iodomethane and potassium carbonate, stirring the materials for reaction, pouring a product into excess ethyl acetate, precipitating a white solid, and washing the white solid with deionized water, followed by vacuum drying to obtain a fourth product; and
(5) dissolving the fourth product in dimethyl sulfoxide, taking supernatant and coating the supernatant on a dry and clean glass plate, followed by drying; and placing an obtained PIL membrane into an alkaline solution for ion exchange, to obtain the high-performance imidazole-based PIL membrane.

2. The preparation method according to claim 1, wherein in step (1), used 2-phenylbenzimidazole or 2,4,5-triphenylimidazole and 4,4′-difluorodiphenyl sulfone, 1,4-dibromobenzene, 4,4′-dibromobiphenyl, or 4,4″-dibromo-p-terphenyl have a molar ratio of 2-8:2-10; the reaction is performed at a temperature of 50-300 °C for a time of 3-20 hours; and the drying is performed at 50-80 °C for 10-25 hours.

3. The preparation method according to claim 1, wherein in step (2), used first product, biphenyl or p-terphenyl and N-methyl-4-piperidone have a molar ratio of 1-7:3-12:2-15; the inert gas is nitrogen or argon; and the reaction is performed at a temperature of −10-20 °C for a time of 2-12 hours.

4. The preparation method according to claim 1, wherein in step (2), the stirring is performed at a speed of 100-800 r·min⁻¹; and the strong organic acid is one or more of trichloroacetic acid, trifluoroacetic acid, and trifluoromethanesulfonic acid, and is added dropwise at a rate of 0.01-10 mL·min⁻¹.

5. The preparation method according to claim 1, wherein in step (3), the alkaline solution is one of a potassium carbonate solution, a sodium carbonate solution, a sodium bicarbonate solution, and a potassium bicarbonate solution, with a concentration of 0.01-15 mol·L⁻¹.

6. The preparation method according to claim 1, wherein in step (3), the washing is performed with deionized water until a pH is 6.5-7.5.

7. The preparation method according to claim 1, wherein in step (3), the stirring is performed for a time of 5-24 hours, and the drying is performed at a temperature of 50-80 °C for a time of 10-30 hours.

8. The preparation method according to claim 1, wherein in step (4), the third product is dissolved in N,N-dimethylformamide, with a solution concentration of 0.05-10%, and the reaction proceeds in the dark; the stirring is performed at a temperature of 30-50 °C for a time of 10-40 hours, with a stirring speed of 100-800 r·min⁻¹; and the vacuum drying is performed at a temperature of 50-80 °C for a time of 10-30 hours.

9. The preparation method according to claim 1, wherein in step (5), the fourth product and dimethyl sulfoxide are prepared into a solution with a concentration of 0.01-15%.

10. The preparation method according to claim 1, wherein in step (5), the obtained PIL membrane undergoes ion exchange in 0.01-5 mol·L⁻¹ NaOH or KOH for 5-72 hours.
